(19) United States
(12) Patent Application Publication
(10) Pub. No.: US 2005/0109779 A1
(43) Pub. Date: May 26, 2005

(54) Melamine dinnerware

(76) Inventor: Yu-Chiao Tseng, Tainan City (TW)

Correspondence Address: TSENG, YU-CHIAO, P.O. BOX 2-10, TAINAN CITY, TW

(21) Appl. No.: 10/846,283

(22) Filed: May 13, 2004

Related U.S. Application Data
(63) Continuation-in-part of application No. 10/725,322, filed on Nov. 24, 2003.

(51) Int. Cl. C03C 10/12

(52) U.S. Cl. 220/23.87

(57) ABSTRACT

A piece of melamine dinnerware includes an outer body made of melamine resin molding compound and an inner body made of stainless steel. The outer body has a bottom and a circumferential wall extending, up from the bottom, and the upper annular edge of the circumferential wall is covered with a leak-preventing ring. The inner body has a bottom and a circumferential wall extending up from the bottom. Then the inner body is placed in the outer body, with the upper edge of the inner body stably resting on the upper edge of the outer body, and with the leak-preventing ring hampering water from flowing or seeping through into a gap formed between the outer body and the inner body.

### FIELD OF THE INVENTION

This invention is continued-in-part of Ser. No. 10/725,322 and the Ser. No. 10/725,322 has been abandoned, this invention relates to melamine dinnerware, particularly to one consisting of an outer body made of powder melamine resin molding compound with high temperature and high pressure by means of injecting molding process and an inner body made of stainless steel, then the outer body and the inner body is assembled together tightly to make a piece of melamine dinnerware.

### BACKGROUND OF THE INVENTION

Conventional melamine dinnerware shown in FIG. 1 is made of melamine resin formed with high temperature and high pressure by an injecting molding machine, having only one layer.

The conventional melamine dinnerware has high-temperature-enduring characteristic, but its also has a comparatively larger capillary holes than that made of metal, and its surface may be liable to be attached with micro dirty matters, and the dirt may become quite hard to be cleaned off after a period of time, resulting to a harassment to users.

### SUMMARY OF THE INVENTION

This invention has been devised to offer melamine dinnerware made of two different materials to make it not easily become dirty, and durable for a long period of time.

The invention has the following features.

1. It has an outer body made of melamine resin and an inner body made of stainless steel, having a comparative pleasant visional appearance and easy to wash and clean and not easily become dirty.

2. The inner body is made of stainless steel first and then combined in the outer body, easy to make this melamine dinnerware.

3. It has an outer body with a circumferential curved-up wall and the upper edge of the circumferential wall covered with a leak-preventing ring so as to prevent water from flowing or seeping in a gap formed between the outer body and the inner body to keep it hygienic.

### BRIEF DESCRIPTION OF DRAWINGS

This invention will be better understood by referring to the accompanying drawings, wherein:

FIG. 1 is a cross-sectional view of a piece of conventional melamine dinnerware;

FIG. 2 is an exploded perspective view of a first embodiment of a piece of melamine dinnerware in the present invention;

FIG. 3 is a partial cross-sectional view of the first embodiment of a piece of melamine dinnerware in the present invention;

FIG. 4 is an upper view of the first embodiment of a piece of melamine dinnerware in the present invention;

FIG. 5 is a cross-sectional view of the line A-A in FIG. 4;

FIG. 6 is a magnified cross-sectional view of the part marked C in FIG. 5;

FIG. 7 is a perspective view of the first embodiment of a piece of melamine dinnerware in the present invention.

FIG. 8 is a cross-sectional view of a second embodiment of a piece of melamine dinnerware in the present invention; and,

FIG. 9 is a cross-sectional view of a third embodiment of a piece of melamine dinnerware in the present inventin.

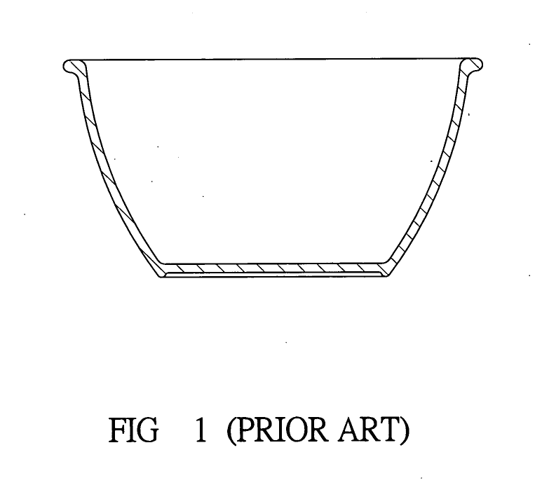

### DETAILED DESCRIPTION OF THE PREFERRED EMBODIMENT

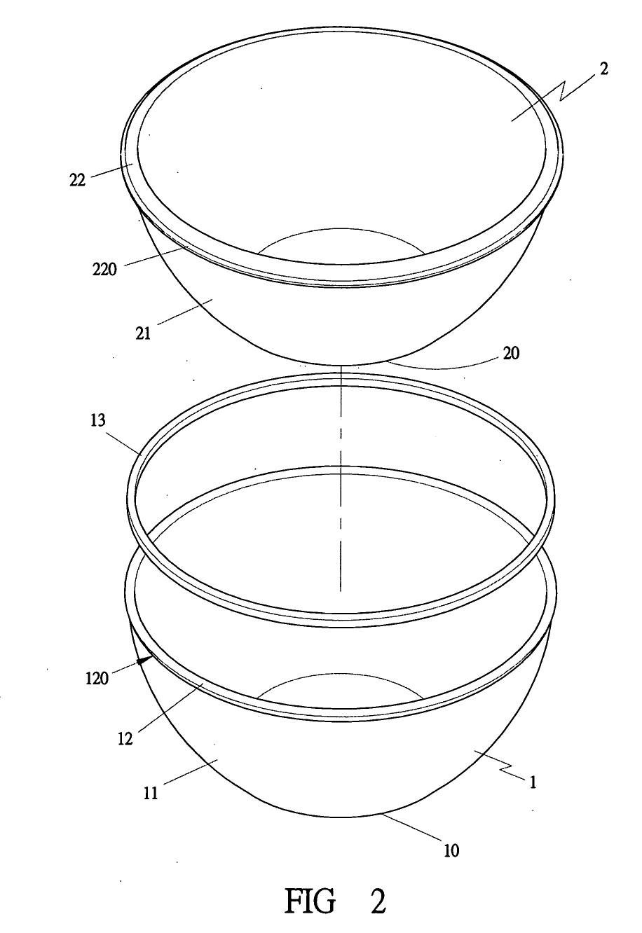

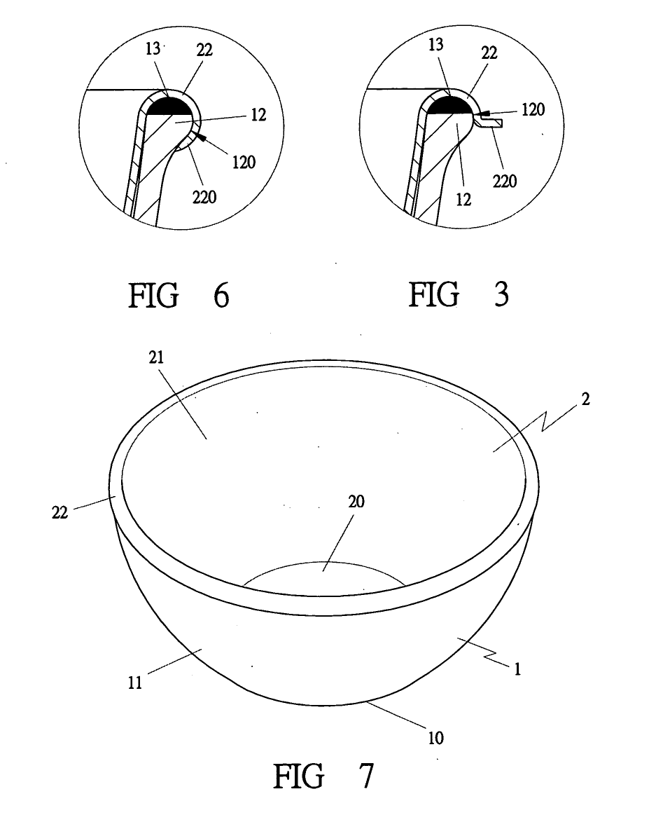

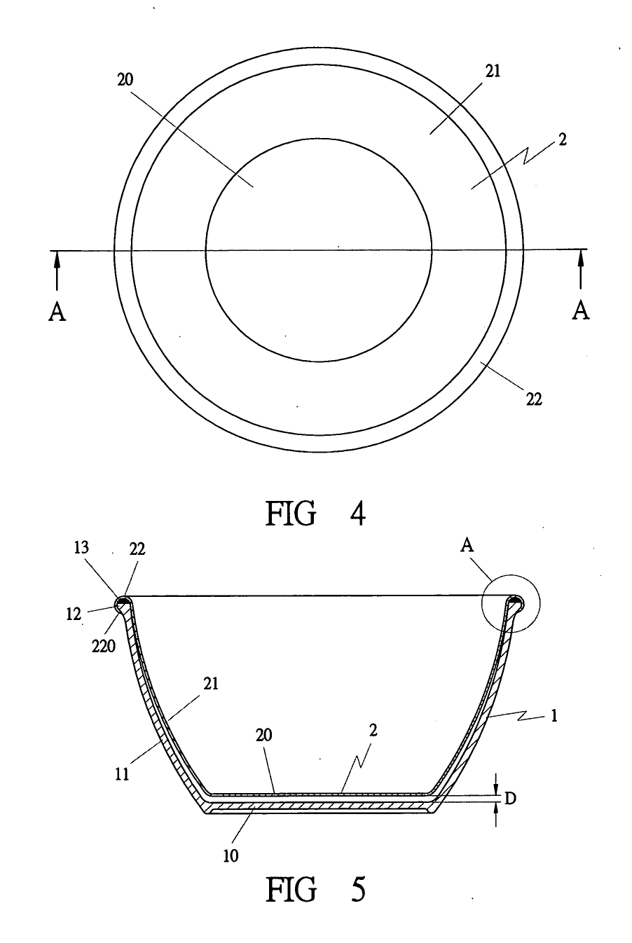

A first preferred embodiment of a piece of melamine dinnerware in the present invention, as shown in FIGS. 2 and 3, includes an outer body 1 and an inner body 2 combined together.

The outer body 1 is made of melamine resin molding compound in powder condition with high temperature and high pressure by means of injecting molding process, having a bottom 10, a circumferential wall 11 extending upward and gradually outward, and an upper annular edge 12 with its curved outer face 120. Further, the upper; annular edge 12 is covered with a leak-preventing ring 13 made of soft material, such as silicon gel, rubber, plastic or the like possible to prevent water from flowing or seeping through it.

The inner body 2 is made of stainless steel, having a bottom 20 to correspond to the bottom 10 of the outer body 1, and a circumferential wall 21 to correspond to the circumferential wall 11 of the outer body 1, and an upper flange 22 with a little extending-out surface 220 as shown in FIGS. 2 and 3, before the inner body 2 is combined with the outer body 1.

Then the inner body 2 is combined with the outer body 1 by placing, it in the outer body 1 with the upper flange 22 resting on and covered completely the upper annular edge 12 of the outer body 1 so as to press tightly the leak-preventing ring 13 of the outer body 1. Then the leak-preventing ring 13 can prevent water from flowing or seeping through into a gap D formed between the outer and the inner body 1 and 2. Between the circumferential wall 21 of the inner body 2 and the circumferential wall 11 of the outer body 1 is formed the heat-insulating gap D. Therefore, when a comparatively hot food is placed in the inner body 2, a holder of this piece of dinnerware can hold the outer body 1 with the hand not to be scalded, as the inner body 2 may not transmit so much of the heat of the food to the outer body 1 owing to separation by the gap D.

Further, the outer body 1 made of melamine resin can be formed with some design on its outer surface to embellish the appearance to look attractive for would-be buyers, with the inner body 2 made of stainless steel easy to wash and not easily attached with micro dirty matters.

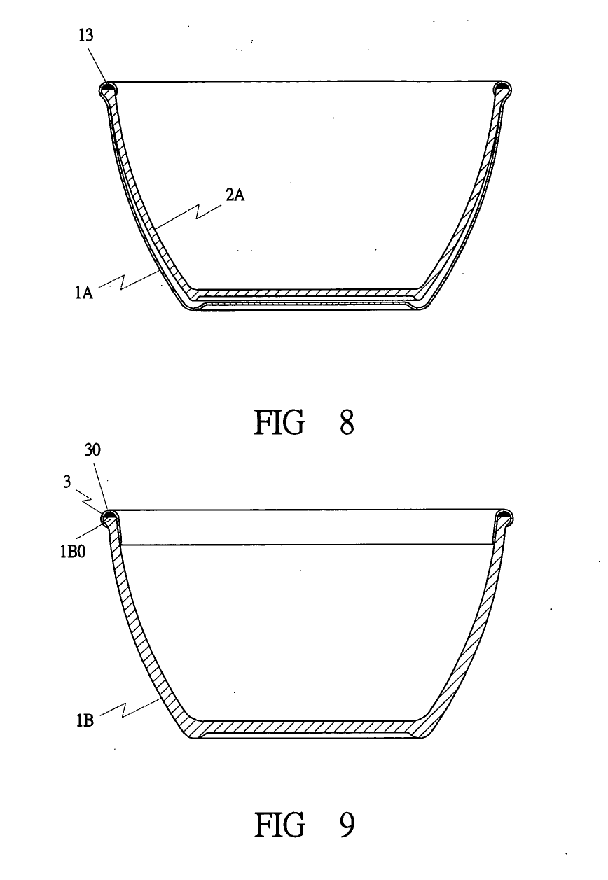

Next, FIG. 8 shows a second embodiment of a piece of melamine dinnerware in the present invention, which is modified from the first one, having the same structure except that an outer body 1A and an inner body 2A have the material interchanged so the outer body 1A is made of stainless steel, and the inner body 2A is made of melamine resin molding compound.

Further, FIG. 9 shows a third embodiment of a piece of melamine dinnerware in the present invention, which is also modified from the first one, having almost the same structure except that an outer body 1B is made of melamine resin molding compound, and a stainless-steel ring 3 inlaid with a leak-preventing ring 30 covers on an annular upper edge 1BO. Therefore, the third embodiment also has the same practical advantage as the first one.

While the preferred embodiment of the invention has been described above, it will be recognized and understood that various modifications may be made therein and the appended claims are intended to cover all such modifications that may fall within the spirit and scope of the invention.

1. A piece of melamine dinnerware comprising:
an outer body made of melamine resin molding compound and having a bottom, a circumferential wall extending from said bottom upward and gradually outward to form an upper annular edge, said circumferential wall having the upper edge covered with a leak-preventing ring:
an inner body made of stainless steel and having a bottom to correspond to the bottom of said outer body, a circumferential wall extending from the bottom to correspond to the circumferential wall of said outer body and formed with an upper flange; and,
said inner body placed in the outer body, with the upper flange resting on the upper annular edge of the outer body, said leak-preventing ring preventing water from flowing or seeping through into the gap between said outer body and said inner body.

2. The piece of melamine dinnerware as claimed in claim 1, wherein said inner body has said upper flange provided with a bit extending-out surface before said inner body is assembled with said outer body.

3. The melamine dinnerware as claimed in claim 1, wherein a heat-insulating gap is provided between said circumferential walls of said outer body and said circumferential wall of said inner body.

4. The melamine dinnerware as claimed in claim 1, wherein said inner body is made of melamine resin molding powder and the outer body is made of stainless steel.

5. The melamine dinnerware as claimed in claim 1, wherein said outer body is made of melamine resin molding compound, and a stainless-steel ring inlaid with a leak-preventing ring is covered on the upper annular edge.
